(19) United States
(12) Patent Application Publication
(10) Pub. No.: US 2026/0025374 A1
(43) Pub. Date: Jan. 22, 2026

(54) REAL-TIME MULTI-USER COLLABORATION THROUGH AUTHENTICATED DATA CONNECTIONS IN NOTEBOOK ENVIRONMENT

(71) Applicant: Hex Technologies, Inc., San Francisco, CA (US)

(72) Inventors: Sukwan Lee, Montreal (CA); Glen Takahashi, San Jose, CA (US); Ganesh Ramanarayanan, San Carlos, CA (US); Caitlin Royden Colgrove, San Francisco, CA (US); Arlo Guneratne Bryer, London (GB); James Lockard, Denver, CO (US); Alexandre Bergeron, Oakland, CA (US)

(21) Appl. No.: 19/274,344

(22) Filed: Jul. 18, 2025

Related U.S. Application Data
(60) Provisional application No. 63/674,082, filed on Jul. 22, 2024.

(51) Int. Cl. H04L 9/40

(52) U.S. Cl. CPC H04L 63/083; H04L 63/105

(57) ABSTRACT

A system enables real-time collaborative access to a notebook environment comprising a plurality of executable cells, including cells that retrieve data from a data warehouse. In response to receiving a request from a first client device operated by a first user to access the notebook, the system determines whether the first user has permission to access the notebook and, if so, presents a first view of the notebook to the first client device. The system receives a request to initiate a collaboration session with a second user and sends an invitation to a second client device. In response to receiving a join request from the second client device, the system verifies access rights and, in response to successful verification, establishes the collaboration session. The system presents a second view of the notebook at the second client device, enabling both users to interact with the shared notebook environment in near real-time.

### CROSS REFERENCE TO RELATED APPLICATION

This application claims the benefit of and priority to U.S. Provisional Patent Application No. 63/674,082, filed on Jul. 22, 2024, the entire contents of which are incorporated herein by reference in their entirety.

### BACKGROUND

### Technical Field

The disclosure generally relates to the field of cell-driven notebook generation, and more specifically relates to enabling collaboration of notebooks among multiple users in a notebook environment.

### Description of Related Art

In a notebook environment, users may generate inter-dependent cells for any number of purposes. The cells may operate using different programming languages or schema, and may perform functions based on activity that occurs in other cells. Some cells are implemented using programming languages tuned to executing within provisioned kernel memory to compute function results (e.g., python cells), while others are tuned to query external resources (e.g., SQL (Structured Query Language) cells). Where a user attempts, using a notebook environment, to run a function on a large dataframe (e.g., one billion rows), and the user does not have sufficient memory to run the function, the operation will fail. The user's recourse in such scenarios is to break down the function into many sub-functions and to call the relevant data stores many times, thus resulting in waste of network bandwidth in making redundant communications, as well as inefficient use of computational resources in performing many sliced tasks instead of dispensing of the task in one attempt.

Further, authentication challenges occur when a cell in a notebook needs to access data from a data warehouse. For instance, various users might have permission to access distinct datasets, although they might all have access to the notebook.

### SUMMARY

The disclosed embodiments include a system or method for enabling secure, real-time collaboration among multiple users in a notebook environment. The system receives a request from a first client device operated by a first user to access a notebook that includes a plurality of cells, at least one of which retrieves data from a data warehouse. In response to verifying the first user's access permissions, the system presents a first view of the notebook at the first client device. The system enables collaborative access by receiving a request to initiate a session with a second user, transmitting an invitation to the second client device, and establishing a collaboration session in response to verifying the second user's access rights. The system presents a second view of the notebook at the second client device. When a cell is executed, results are generated and cached with an associated access token or role. The system controls access to cached results based on token equivalence or role-based authorization logic, and enables control transfer between users with synchronized result propagation across view.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

Figure (FIG. 1 illustrates an example system environment for implementing a notebook tool in accordance with one or more embodiments.

FIG. 2 illustrates an example architecture of a notebook tool in accordance with one or more embodiments.

FIG. 3 illustrates an exemplary user interface for generating and running a cell, in accordance with one or more embodiments.

FIG. 4 illustrates a flow of authenticating a user during execution of code in a notebook in accordance with one or more embodiments.

FIGS. 5A and 5B illustrate example user interface of a notebook application in accordance with one or more embodiments.

FIG. 6A illustrates a flow of securing sharing a notebook and data connection between a first user (user A) and a second user (user B) in accordance with one or more embodiment.

FIG. 6B illustrates a flow of securing sharing a notebook and data connection between a first user (user A) and a second user (user B) in accordance with one or more embodiments.

FIG. 6C illustrates a flow of caching results of executed cells by a first user (user A) and sharing the cached results with a second user (user B) in accordance with one or more embodiments.

FIG. 7A is a flowchart of a method for secure data access and execution in a notebook environment in accordance with one or more embodiments.

FIG. 7B illustrates a flowchart of a method for sharing results from executing cells of a notebook using data stored at a data warehouse, in accordance with one or more embodiments.

FIG. 8 is a block diagram illustrating components of an example machine able to read instructions from a machine-readable medium and execute them in a processor (or controller), in accordance with one or more embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Conventional notebook environments lack robust mechanisms for enabling secure, real-time collaboration among multiple users with differing data access permissions. When collaborating on notebooks that retrieve data from external warehouses, users often either share credentials insecurely or are forced to use a single, centralized account-undermining fine-grained access control and auditability. Additionally, existing systems do not support dynamic views based on user roles, nor do they handle data caching in a way that respects user-specific authorization constraints. These limitations hinder enterprise collaboration, create compliance risks, and reduce the effectiveness of multi-user workflows in data-driven environments.

The embodiments described herein address the above-described problem by integrating role-based access control and token-authenticated data retrieval. Each user accesses the notebook with their own credentials, and the system dynamically generates notebook views and execution permissions based on role or token metadata. Execution results are cached in association with the user's access token or role identifier, and access to cached results by other collaborators is conditionally permitted based on token equivalence, role matching, or authenticated permission validation. The system further enables control transfer between users while maintaining synchronization and enforcing access boundaries, thereby allowing collaboration without compromising security or data governance. Additional details about the system are further described below with respect to FIGS. 1-8.

Figure (FIG. 1 illustrates one embodiment of a system environment for implementing a notebook tool. As depicted in FIG. 1, environment 100 includes client device 110 with notebook application 111 installed thereon, network 120, notebook tool 130, data warehouse 140, and an authentication service 150. Client device 110 may be any device having a user interface usable to interact with a notebook via notebook application 111 and/or notebook tool 130. Exemplary client devices may include personal computers, laptops, tablets, smartphones, and so on. While only one client device 110 is depicted, any number of client devices may be used. Multiple client devices may be used at a same time to access and otherwise collaborate on a same notebook.

Notebook application 111 may be a dedicated application installed on client device 110 for using a notebook. Notebook application 111 may be installed directly or indirectly from notebook tool 130 (e.g., downloaded from notebook tool 130; downloaded from an application store; from a hard drive having installation code, and so on). The notebook may in whole or in part be stored in the cloud (e.g., using notebook tool 130) and/or local to client device 110. Notebook application 111 may be a browser through which a notebook may be accessed from notebook tool 130. The term notebook, as used herein, may refer to an application that accepts inputs in any number of code languages (e.g., Python, SQL (Structured Query Language), and so on) and/or non-code languages (e.g., spreadsheet format, text format, etc.). The inputs may each form individual cells, or may command combinations of inputs that together form cells. Cells may be connected in a DAG structure, with directed edges pointing between one another that reflect dependencies among cells. The DAG structure and further details about notebook operation are discussed in further detail in U.S. patent application Ser. No. 18/299,682, filed Apr. 12, 2023. References to activity performed by notebook application 111 are merely exemplary, and that same functionality may, wherever notebook application 111 is referred to, be performed in whole or in part by notebook tool 130. That is, activity described herein as performed by notebook application 111 may be performed on-device, on-cloud (using notebook tool 130), or may be distributed with partial performance by each entity.

Network 120 may be a data communication channel between client device 110, notebook tool 130, and data warehouse 140. The data communication channel may be any channel usable to transmit communications between these entities, such as the Internet, a local area network, a wireless network, a short-range communications network, and so on. Network 120 may facilitate communication between any number of client devices and external servers and services beyond those depicted in environment 100.

Notebook tool 130 may be a cloud-based provider that stores notebooks and provides functionality described herein with respect to notebooks. All functionality described herein with respect to notebook application 111 may be performed by notebook tool 130, and all functionality described herein with respect to notebook tool 130 may be performed by notebook application 111 in part or in whole. Distributed processing where some activity described is performed by notebook application 111 and other activity described is performed by notebook tool 130 is implied as within the scope of what is described even where processing is only described with respect to one of the two entities herein.

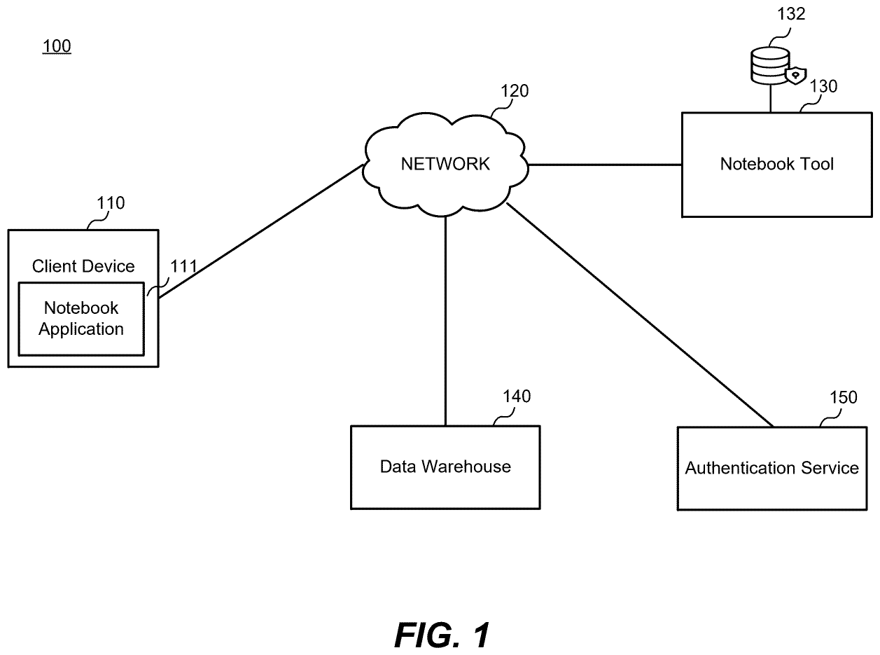

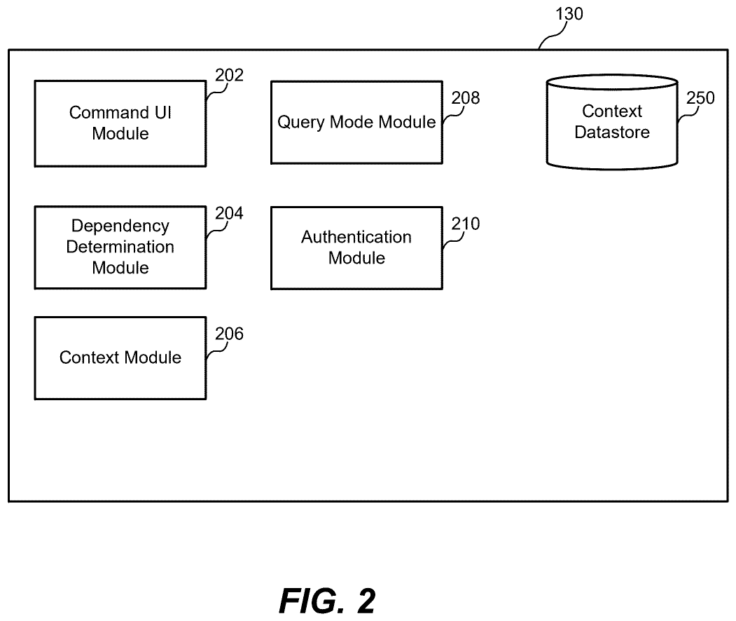

In some embodiments, multiple client devices associated with different users may each operate an instance of notebook application 111 to collaboratively access and interact with the same notebook. The notebook tool 130 enables real-time or near real-time synchronization of notebook state across all participating client devices by maintaining a shared session. Each user may view, edit, and/or execute cells in the notebook depending on their assigned permissions, with updates made by one user being propagated to others. Collaboration may be coordinated through mechanisms such as session control transfer, shared views, and role-aware content visibility. The system ensures that execution results, data previews, and edits are correctly reflected across devices while preserving each user's identity and access privileges, thereby supporting secure multi-user workflows in a shared notebook environment. Further details about the functionality of notebook tool 130 are described below with respect to FIG. 2.

Data warehouse 140 is depicted as one data warehouse and is recited in the singular, but may include any number of data warehouses provided by any number of providers, which may use their own schema in storing and querying data. Notebook application 111 may be provisioned with a data connector that translates commands from a schema used by notebook application 111 to be compatible with data warehouse 140. Each respective data connector may support and translate bidirectional communications between notebook application 111 and a respective data warehouse 140. Notebook application 111 may use dedicated memory (e.g., memory of client device 110 and/or cloud memory provisioned by notebook tool 130) for local functions, such as processing python script. Notebook application 111 may use memory of data warehouse for remote functions such as data queries and data synthesis. Further details about optimally splitting workloads between notebook application 111 and data warehouse 140 is discussed in further detail below.

The authentication service 150 is a system or software that verifies an identity of a user of a client device 110 who attempts to access the notebook application 111 and/or the data warehouse 140. The authentication service 150 may include (but is not limited to) Microsoft Azure Active Directory (Azure AD), Okta, Auth0, Google Identity Platform, Duo Security, etc. The authentication service 150 ensures that only authorized users or devices are granted access by validating their credentials against a secure database. In some embodiments, the authentication service 150 checks provided credentials (such as, but not limited to usernames, passwords, biometric data) to confirm the users' identities. In some embodiments, the authentication service 150 uses specific protocols such as OAuth, SAML, or LDAP to manage and secure the authentication process. In some embodiments, the authentication service 150 may offer multi-factor authentication to enhance security by requiring multiple forms of verification beyond just a password, such as a text message code, an authentication app, and/or fingerprint, etc. In some embodiments, the authentication service 150 may offer single sign-on, which allows users to authenticate once and gain access to multiple related systems without re-authenticating. After authentication, the authentication service 150 manages the user's session to ensure that the authentication remains valid over time and logs out the user after inactivity or manually ending the session.

In some embodiments, the notebook tool 130 includes or has access to a data store 132, which is configured to securely store users' access tokens obtained from the authentication service 150. Once a user's credentials are authenticated, the authentication service 150 generates an access token and sends it to the data store 132. The data store 132 then securely stores the access token, eliminating the need for users to repeatedly re-enter their credentials. This enhances the user experience and reduces the computational load on authentication operations. In some embodiments, the access token is encrypted before being stored in the data store 132. Users can set a validity period for the access token through the authentication service and may revoke or delete the access token from the data store 132 at any time.

When a user initiates execution of a cell containing a query-such as an SQL statement-against a dataset stored in the data warehouse 140, the notebook tool 130 may retrieve the user's access token from data store 132 and appends it to the data request. The data warehouse 140 validates the token with the authentication service 150 to determine whether the user has sufficient permissions to access the requested dataset. In response to successful authentication, the data warehouse 140 transmits the requested data to the notebook tool 130, which then executes the query and generates a corresponding output. In some embodiments, this output is considered protected content and may inherit the same authentication level or access restrictions as the underlying dataset. As such, access to the output—whether in raw or cached form—may be limited to users possessing an equivalent access token, matching permission level, or authorized role, thereby preserving data security even in collaborative notebook environments.

FIG. 2 illustrates one embodiment of modules of the notebook tool. As depicted, notebook tool 130 includes command UI (user interface) module 202, dependency determination module 204, context module 206, query mode module 208, authentication module 210 and context datastore 250. The modules and datastores depicted in FIG. 2 are merely exemplary; any number of modules and/or datastores may be used to achieve the functionality disclosed herein. Moreover, as mentioned above, while the modules and datastore are illustrated and described with respect to notebook tool 130, some or all of the operation of these modules and/or datastores may part of notebook application 111 operating on client device 110, thus accommodating on-device operation in whole, or distributed processing between notebook application 111 and notebook tool 130.

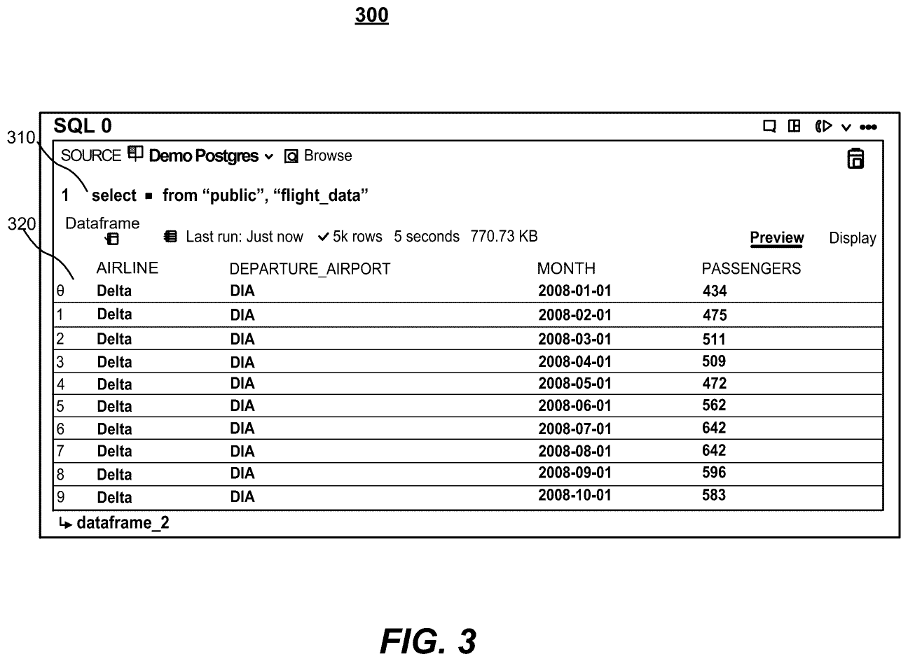

Command UI module 202 receives inputs in cells of a notebook. Turning for the moment to FIG. 3, FIG. 3 illustrates an exemplary user interface for generating a cell, in accordance with an embodiment. User interface 300 may include multiple cells each having their own interface, where different cells may be used to generate code versus generating markdown (e.g., tables, text, etc.) versus generating SQ and so on. These are merely exemplary; any number of cells may be generated or part of user interface 300, and the cells may use any language (other code languages like Python, natural language, spreadsheet, or any other language is within the scope of the disclosure). As depicted, user interface 300 shows a selection of a source of “Demo Postgres”, which is a data warehouse of data warehouse 140. Interface 310 accepts input in a native language to notebook application 111, such as python, to perform a command. The command in this case is to select all rows of public flight information from a dataframe called flight_data. Interface 320 may preview or do a full display of the results of the command being executed.

Cells may be generated from scratch or may be generated using pre-existing components. To use pre-existing components, user interface 300 may display a selectable component option (not depicted), which may lead to a library of components. A user may select from the library a component, and responsive to doing so, command UI module 202 will add the component as a cell to user interface 300. For example, rather than type in the python script to access the flight data, a user may have selected a component with the python script already populated. To generate cells from scratch, in an embodiment, a user may add text to the cell's associated interface (e.g., manually type code, SQL, markdown, python, and so on).

In an embodiment, command UI module 202 may receive a natural language command to automatically generate code. For example, command UI module 202 may receive a command to “obtain public flight data from postgres”. Responsive to receiving such a command, command UI module 202 may pass as input to a supervised machine learning model, such as a generative machine learning model, the command, and may receive as output from the supervised machine learning model a response which command UI module 202 uses to form the code in the cell.

In a notebook structure having many cells that have myriad dependencies, considering state of dependent cells is required to avoid inaccuracies where the cell implicated by the request depends on other cells. Thus, the context of dependent cells is considered in processing commands within a cell. Dependency determination module 204 determines dependencies of the cell, and command UI module 202 may additionally pass the dependencies and/or the cells on which the command cell depends to whatever function is executing the cell.

In some embodiments, the authentication module 210 is configured to interact with the authentications service 150 to authenticate users' identities. In some embodiments, the authentication module 210 causes a user interface to be presented at a client device 110 where the user enters their authentication credentials, such as a username and a password, biometric data (e.g., fingerprint or facial recognition), or a multi-factor authentication prompt. Responsive to receiving user credentials, the client device 110 is caused to send this data to the authentication service 150, e.g., through a secure API call. The authentication service 150 receives the credentials and verifies them against its stored data. This could involve checking a username and password against a database, or checking biometric data against registered information. If the credentials are verified successfully, the authentication service 150 may send a positive response back to the client device 110 or the authentication module 210, often including a token or a session key that the authentication module 210 can use to maintain the user's logged-in state. If the credentials do not match, the authentication service 150 may send a failure response. The client device 110 or the authentication module 210 may then inform the user of the failure and may allow them to retry.

In some embodiments, when a cell of code includes code that requires access to data stored in the data warehouse 140, the authentication module 210 passes a data request along with the token to the data warehouse 140, causing the data warehouse 140 to verify the received token with the authentication service 150. Only when the token is verified with the authentication service 150, the data warehouse 140 will grant the data request from the authentication module 210 of the notebook tool 130.

In some embodiments, the data warehouse 140 assigns each user a role, which is associated with specific access permissions to different data resources. The authentication process includes verifying whether the role of the user has access permission to the requested data. Responsive to verifying that the role of the user has access permission to the requested data, the data warehouse 140 grants the data request.

Responsive to the data request being granted, the notebook tool 130 can successfully execute the cell of code. Responsive to the data request not being granted, the notebook tool 130 generates an error message, indicating that the user does not have access to the requested data.

In the context of a collaborative notebook session involving multiple users, the authentication module 210 may further be configured to help managing secure and individualized access to shared notebook content. When a collaboration session is established between a first user and a second user, each operating a separate client device 110, the authentication module 210 may maintain a distinct authentication context for each user. This ensures that any execution of a cell requiring access to the data warehouse 140 is performed using the access token and role permissions associated with the currently active user. In response to the second user attempting to execute a cell previously created or executed by the first user, the authentication module 210 transmits the second user's access token—rather than reusing the first user's token—to the data warehouse 140, thereby enforcing user-specific access controls within the shared notebook environment.

Additionally, in some embodiments, the authentication module 210 facilitates transitions in notebook control between users. When a second user requests to take control of the collaborative session—for example, to edit or execute additional cells—the authentication module 210 updates the execution context to reflect the second user's identity and access token. The module also determines whether cached results generated by the first user may be presented to the second user, based on token equivalence or role-level access validation. This dynamic control ensures that execution privileges and data visibility within the shared notebook are continuously governed by up-to-date authentication information, thereby preventing unauthorized access while enabling multi-user interaction.

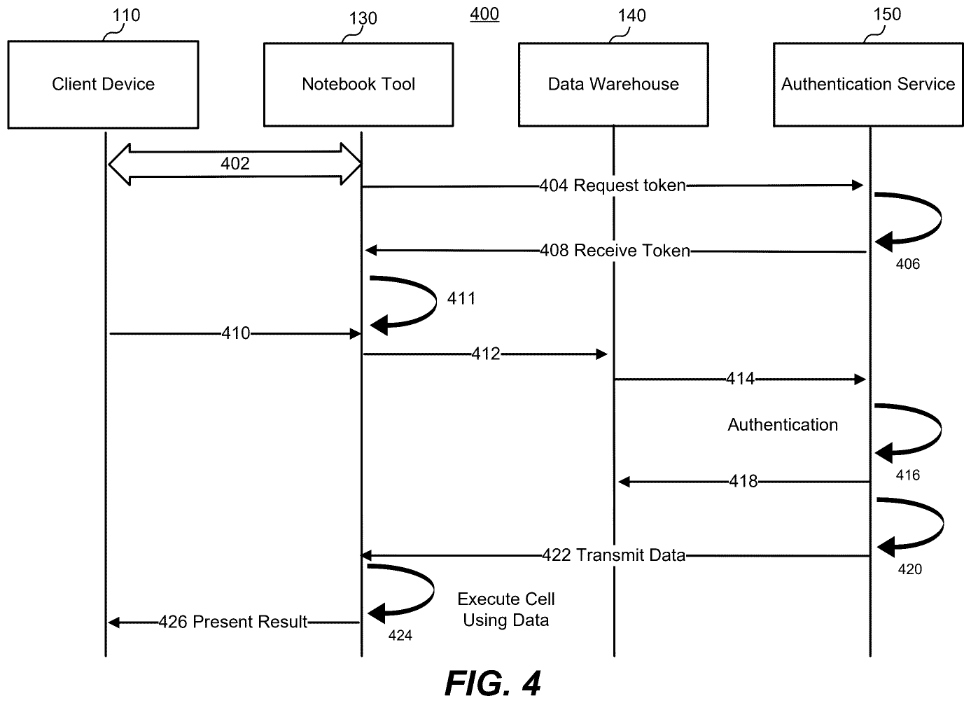

FIG. 4 is a diagram depicting a flow 400 of authenticating a user during execution of code in a notebook in accordance with one or more embodiments. Flow 400 may begin with a user's client device 110 establishing communication with the notebook tool 130 (represented by arrow 402), such that a notebook is displayed on a user interface of the notebook application 111 on the client device 110. In some embodiments, this communication between the client device 110 and the notebook tool 130 may be established via a third party authentication service, such as authentication service 150. Alternatively, the communication between the client device 110 and the notebook tool 130 may be established by an internal authentication service coupled to the notebook tool 130. After the communication is established, via the notebook application 111, the user is able to review and edit the notebook. The user may also be able to execute code in the notebook that does not require access to data stored at the data warehouse 140.

Notably, some code cells include code that requires access to data stored at the data warehouse 140 that is accessible only by authorized users. When such a cell is to be executed, the user's client device 110 needs to provide an access token to the notebook tool 130. This access token is then forwarded to the data warehouse 140, where it is used for authentication with the authentication service 150.

To obtain the access token, the notebook tool 130 sends a request to the authentication service 150 (represented by arrow 404). The request may include the user's credentials, such as username and password. Responsive to receiving the request, the authentication service 150 verifies the user's credentials (represented by arrow 406). Responsive to successful verification of the user's credentials, the authentication service 150 generates and sends an access token to the notebook tool 130 (represented by arrow 408). Responsive to receiving the access token, the notebook tool 130 securely stores the access token (represented by arrow 411). In some embodiments, the access token is encrypted and then stored.

When the client device 110 requests to execute the cell of code (represented by arrow 410), the notebook tool 130 sends a request for data, along with the access token to the data warehouse 140 (represented by arrow 412). The data warehouse 140 then passes the access token to the authentication service 150 (represented by arrow 414), causing the authentication service 150 to authenticate the access token (represented by arrow 416). In response to determining, by the authentication service 150, that the received access token is the same as the access token previously issued and is still valid, the authentication service 150 sends a message to the data warehouse 140, indicating successful authentication of the user's identity (represented by arrow 418).

Responsive to receiving the positive message from the authentication service 150, the data warehouse 140 recognizes that the user's identity has been verified. Although the user's identity is verified, user permissions to access data may vary. Therefore, the data warehouse 140 proceeds to determine whether the authenticated user is authorized to access the requested data (represented by arrow 420). For example, the data warehouse 140 may determine whether the user is associated with a role that has permission to access the requested data. Responsive to determining that the authenticated user has permission to access the requested data, the data warehouse 140 sends the requested data to the notebook tool 130 (represented by arrow 422). After receiving the requested data, the notebook tool 130 can then execute the cell of code using the received data to generate results (represented by arrow 424). The results are then transmitted to the client device 110 for display (represented by arrow 426).

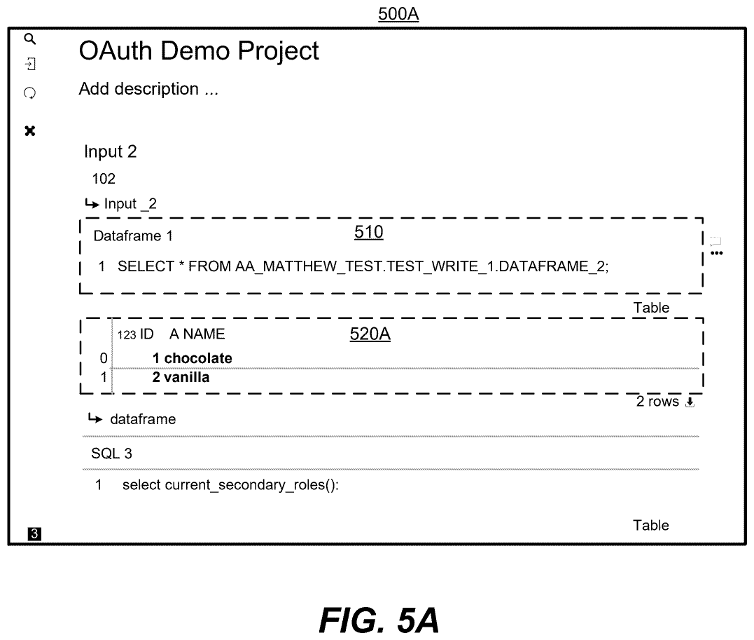

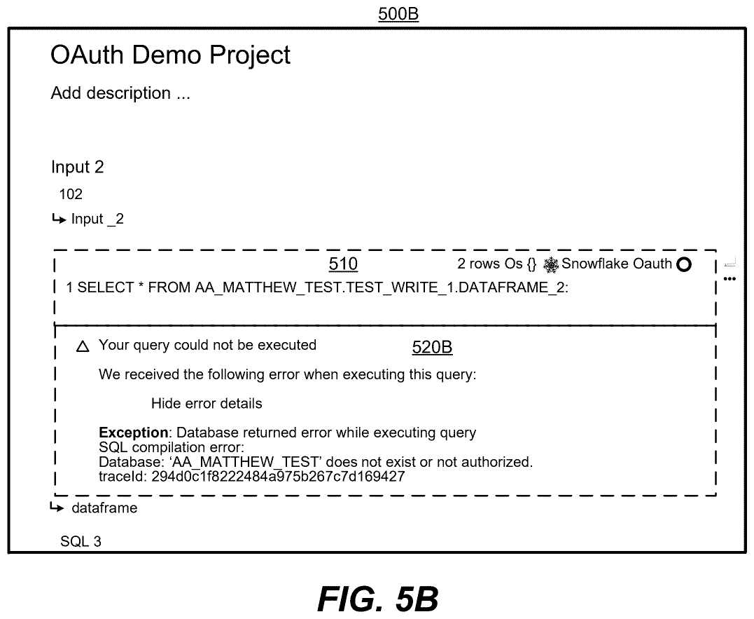

FIGS. 5A and 5B illustrate example user interface 500A or 500B of a notebook application 111 in accordance with one or more embodiments. As illustrated in FIG. 5A, the notebook includes a cell 510. The cell 510 includes one line of code, “SELECT*FROM AA_MATTHEW_TEST.TEST_WRITE_1.DATAFRAME_2”. This line of code is an SQL query configured to retrieve all the columns and rows of data from a table named DATAFRAME_2 located within the database schema TEST_WRITE_1 of the database AA_MATTHEW_TEST. The SELECT*statement specifies that all columns in the table should be included in the results. In some embodiments, the notebook tool 130 functions as a credential-aware pass-through, delegating all access control decisions to the data warehouse 140. In response to a user attempting to access a table or schema without the necessary permissions, the data warehouse returns an authorization error, which is surfaced to the user via the notebook interface. The notebook tool 130 does not itself maintain or enforce granular access controls on warehouse data.

Because this line of code requires the access to the database AA_MATTHEW_TEST, the authentication process described with respect to FIG. 4 applies. In FIG. 5A, a user is successfully authenticated, and the notebook tool 130 is able to receive the requested data, and execute the code in cell 510 to output results 520A. On the other hand, in FIG. 5B, a user is not successfully authenticated, and the notebook tool 130 is not able to receive the requested data, resulting in an exception. The notebook tool 130 outputs an error message 520B, notifying the user the exception.

Although the example embodiments illustrate OAuth-based authentication, one of ordinary skill in the art will understand that the disclosed techniques are adaptable to a broad range of authentication providers and protocols. In some embodiments, the authentication module may integrate with identity platforms such as SAML, LDAP, or proprietary enterprise single sign-on (SSO) frameworks. To support interoperability, in some embodiments, the system may provide an authentication interface that accepts tokens, roles, or other authorization artifacts issued by any compliant authentication provider. As such, the embodiments described herein allow users to securely share their notebooks and collaborate with each other via various authentication protocols and services.

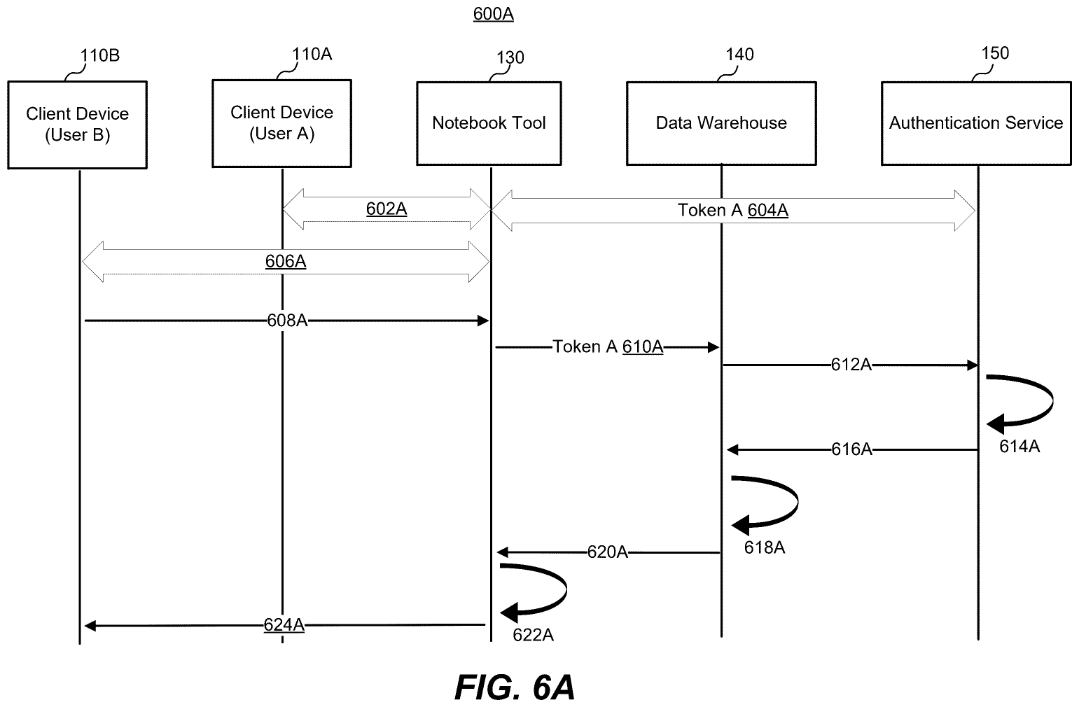

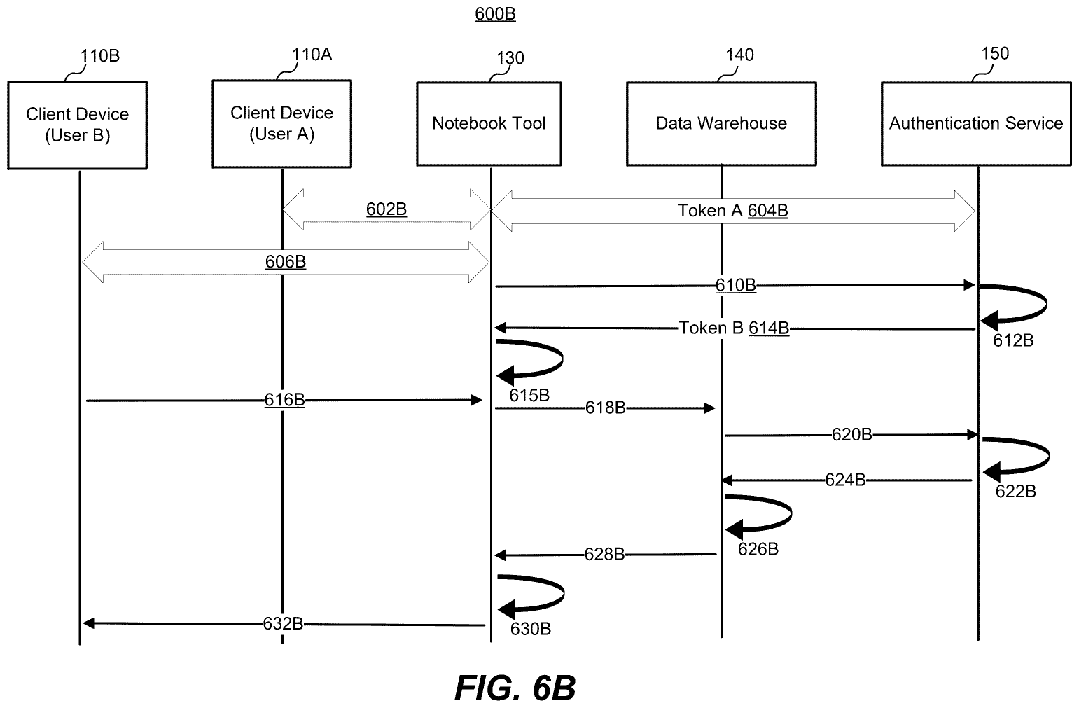

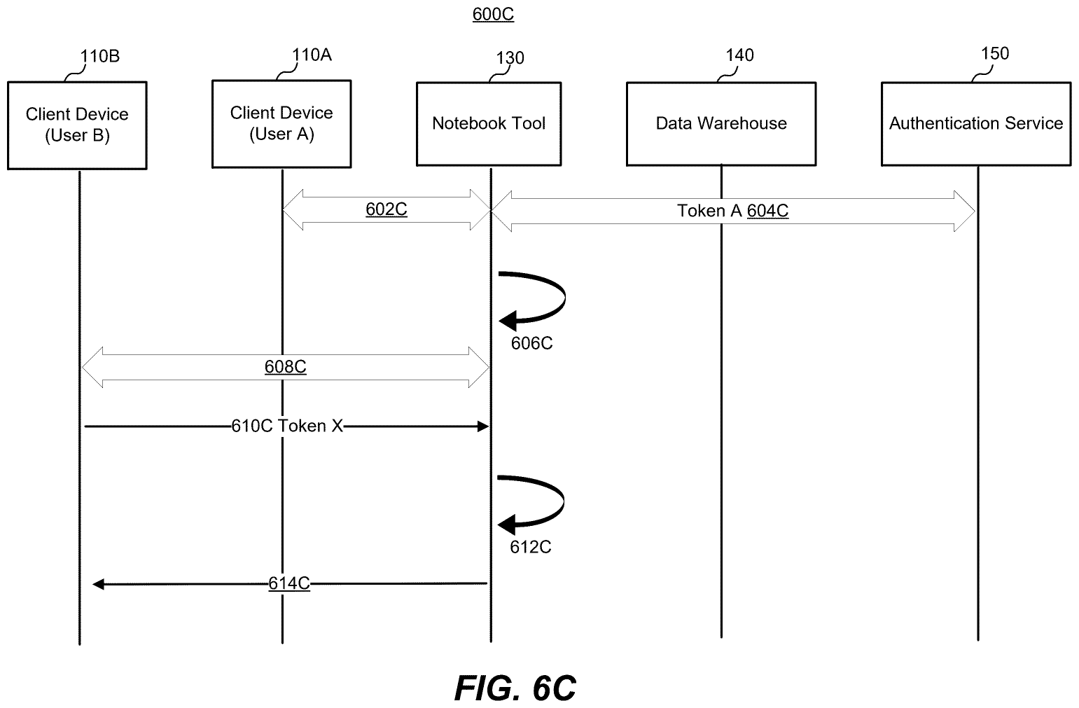

FIG. 6A is a diagram depicting a flow 600A of securing sharing a notebook and data connection between a first user (user A) and a second user (user B) in accordance with one embodiment. In this embodiment, user A grants user B permission to access a notebook and its associated data stored in the data warehouse, acting on user A's behalf.

As illustrated, user A is associated with client device 110A, and user B is associated with client device 110B. User A may have created a notebook, and has established access to data stored at data warehouse 140 via an access token “token A” (represented by arrows 602A and 604A). User A then grants user B access to the notebook on behalf of user A, as such, user B is able to access the notebook via the notebook tool 130 (represented by arrow 606A). This access allows user B to review and edit the cells in the notebook, and execute cells with or without requirement of data stored at data warehouse 140 on behalf of user A. When user B requests to execute a cell of code in the notebook that requires access to data stored at data warehouse 140 (represented by arrow 608A), the notebook tool 130 sends token A (previously obtained from user A) to the data warehouse 140 (represented by arrow 610A). The data warehouse 140 sends the received token A to the authentication service 150 (represented by arrow 612A). The authentication service 150 then authenticates the token A as being issued for user A (represented by arrow 614A), and sends back the successful authentication result back to the data warehouse 140 (represented by arrow 616A). Responsive to receiving the successful authentication result from the authentication service 150, the data warehouse 140 determines whether the authenticated user is authorized to access the requested data (represented by arrow 618A). If the user is authorized, the data warehouse 140 permits the notebook tool 130 to access the requested data (represented by arrow 620A). As such, the notebook tool 130 can execute the code cell using the requested data to generate results (represented by arrow 622A), and send the results to the client device 110B associated with user B (represented by arrow 624A).

FIG. 6B is a diagram depicting a flow 600B of securely sharing a notebook and data connection between a first user (user A) and a second user (user B) in accordance with another embodiment. In this embodiment, user A merely grants user B permission to access a notebook. If a cell in the notebook needs access to data stored in the data warehouse 140, user B's identity must be authenticated by the data warehouse 140 before the data can be accessed by the cell in the notebook.

Again, user A is associated with client device 110A, and user B is associated with client device 110B. User A generates a notebook that includes cells that need access to data stored at data warehouse 140, and user A has authenticated their identity with the data warehouse 140 (represented by arrows 602B and 604B). User A grants user B permission to access the notebook, such that user B is able to view and edit the notebook. Client device 110B associated with user B then accesses the notebook via the notebook tool 130 (represented by arrow 606B). Similar to the steps for authenticating user A, the notebook tool 130 obtains user B's credentials and sends user B's credentials to the authentication service 150 (represented by arrow 610B), causing the authentication service 150 to verify the identity of user B, and generates an access token, token B (represented by arrow 612B). The authentication service 150 sends token B to the notebook tool 130 (represented by arrow 614B). Notebook tool 130 securely stores token B (represented by arrow 615B), which may include encryption.

When client device 110B requests to execute the cell, (represented by arrow 616B), the notebook tool 130 sends a request for data along with token B to the data warehouse 140 (represented by arrow 618B). The data warehouse 140 in turn sends token B to the authentication service 150 (represented by arrow 620B). The authentication service 150 then authenticates token B to determine whether the received token is same as a previously issued token (represented by arrow 622B). The authentication service 150 sends the successful authentication result to the data warehouse 140 (represented by arrow 624B). Responsive to receiving the successful authentication result from the authentication service 150, the data warehouse 140 determines whether user B is authorized to access the requested data (represented by arrow 626B). If user B is authorized, the data warehouse 140 allows the notebook tool 130 to access the requested data (represented by arrow 628B). The notebook tool 130 can then execute the cell of code to output results (represented by arrow 630B) and send the results back to the client device 110B (represented by arrow 632B).

In some embodiments, after a user has successfully executed a cell of code using data stored in the data warehouse to output results, the results are cached with the notebook tool 130 or become a part of the notebook (as illustrated in FIG. 5A). In some embodiments, the notebook tool 130 may cache the results with an access token associated with the user, which can later be used to determine whether the cached results can be accessed by the same user or another user.

FIG. 6C illustrates a flow 600C of caching results of executed cells by a first user (e.g., user A) and sharing the cached results with a second user (e.g., user B) in accordance with one or more embodiments. As illustrated, user A is associated with client device 110A, and user B is associated with client device 110B. User A generates a notebook that includes cells that need access to data stored at data warehouse 140, and user A has authenticated their identity with the data warehouse 140 using token A (represented by arrows 602B and 604B). A cell that needs access to data stored at data warehouse 140 is executed by user A via client device 110A. The notebook tool 130 caches results output from the execution of the cell relationally with the user A's token (e.g., token A) (represented by arrow 606C). Later, when the user A accesses the notebook again using token A, the notebook tool 130 retrieves the notebook containing the cached results and their associated token(s). Notebook tool 130 determines that token A presented by user A matches a token associated with the cached results, and presents the cached results to user A. As such, user A does not need to re-execute the cell again.

Further, user A can also share the notebook with another user, e.g., user B. After user A shares the notebook with user B, client device 100B associated with user B is able to establish a connection with notebook tool 130 (represented by arrow 606A). In response to establishing the connection with notebook tool 130, user B is able to access the notebook via the notebook application on the client device 110B.

However, user B may or may not have permission to access the cached results of the cell previously executed by user A depending on whether user A has explicitly granted user B such permission or whether user B is authorized to access the required data stored in the data warehouse to execute the cell. In some embodiments, for user B to access the cached results, client device 110B associated with user B sends an access token to the notebook tool 130, which then determines whether the access token is associated with the results of the notebook cell. In some embodiments, when user A shares the notebook with user B, client device 110A also shares token A with client device 110B, such that client device 110B associated with user B can access the notebook on behalf of user A, and user B is able to access the cached results without further authentication from the data warehouse 140.

Alternatively, user B is not allowed to access the cached results unless their own access token (token B) is authenticated by the authentication service 150. In some embodiments, only when it is authenticated that user B has permission to access required data stored in the data warehouse 140 to execute the cell, user B is granted access to the cached results. In some embodiments, the authentication does not have to go through the data warehouse 140, as long as it is authenticated that user A and user B are assigned a same role within an organization, user B is allowed to access the results. In response to successful authentication of user B via user B's token (token B), user B's token (token B) is also relationally stored with the results of the executed cell. Later, when user B accesses the notebook again, the notebook tool 130 will allow user B to access the results without further authentication because user B's access token matches one of the tokens associated with the notebook cell.

In some embodiments, cached results or schema metadata are associated not only with individual user tokens, but also with roles or role sets. When a second user attempts to access a cached result or schema, the notebook tool 130 determines whether the second user's assigned roles are equivalent to, or a superset of, the roles associated with the cached entry. If so, the cached result or schema is considered valid for that user, and access is granted without re-executing the query or refreshing schema metadata.

In some embodiments, the notebook tool 130 generates and stores a schema view tailored to each user or role. When a user connects to a shared notebook and explores a data connection (e.g., via a schema browser), the displayed schema reflects only the subset of tables and columns that the user is permitted to access based on their authenticated credentials. In some embodiments, the system may generate and cache distinct schema views based on role permutations rather than individual user identities. When a user accesses a data connection, the system queries the warehouse to retrieve the schema information available to the user's roles. This schema view is then cached and indexed according to the resolved set of roles, rather than to the specific user. If another user with the same role permutation accesses the same connection, the cached schema view is reused, reducing latency and load on the underlying warehouse. For example, enterprise users are often assigned to predefined role groups, making role-based schema caching both scalable and secure. Such schema cache entries may be invalidated or refreshed as warehouse permissions change.

In some embodiments, role equivalency is not limited to exact matches. If the access permissions associated with a second user's role are a strict superset of those associated with a cached result, the notebook tool 130 may determine that the second user is permitted to access the cached result, provided that the relevant data falls entirely within the overlapping permission set. For example, when a user executes a query that retrieves data from a data warehouse, the resulting output may be cached along with metadata identifying the role or roles used to authorize that access. If another user subsequently attempts to access the same cached result, the system determines whether that user's assigned role encompasses all the access privileges of the original role—that is, whether it is a superset. If so, the system allows reuse of the cached result without requiring re-execution of the query. This logic supports efficient sharing in collaborative environments where users with broader access should not be penalized with redundant query execution, while still preserving security and governance boundaries.

In some embodiments, users may elect to embed their credentials into published applications generated from a notebook. This allows unauthenticated viewers, such as non-technical stakeholders, to interact with published content backed by secure data queries. The embedded credentials are not exposed to the viewer but are used under the hood to execute live queries. Organizational administrators may define policies to restrict or prohibit credential embedding, ensuring compliance with data governance protocols. In existing implementations, schema metadata is refreshed on demand by the user currently interacting with the data connection. The credentials used during this refresh operation determine the visible schema structure, which may inadvertently expose or hide tables relative to other collaborators. To mitigate this, future enhancements include maintaining separate schema caches per user or per role, ensuring that each collaborator views only authorized portions of the schema.

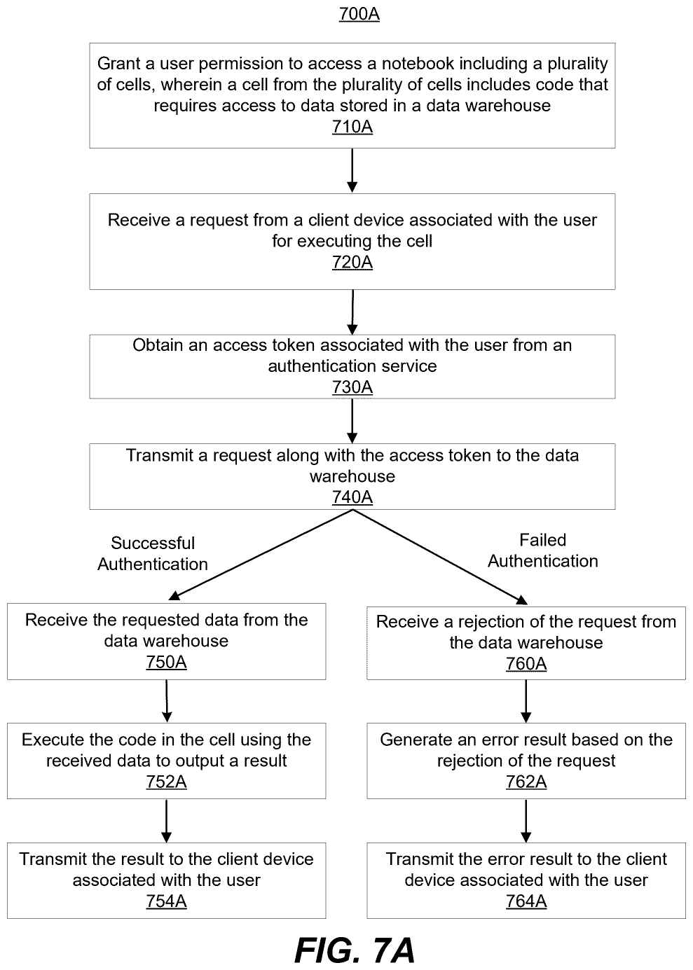

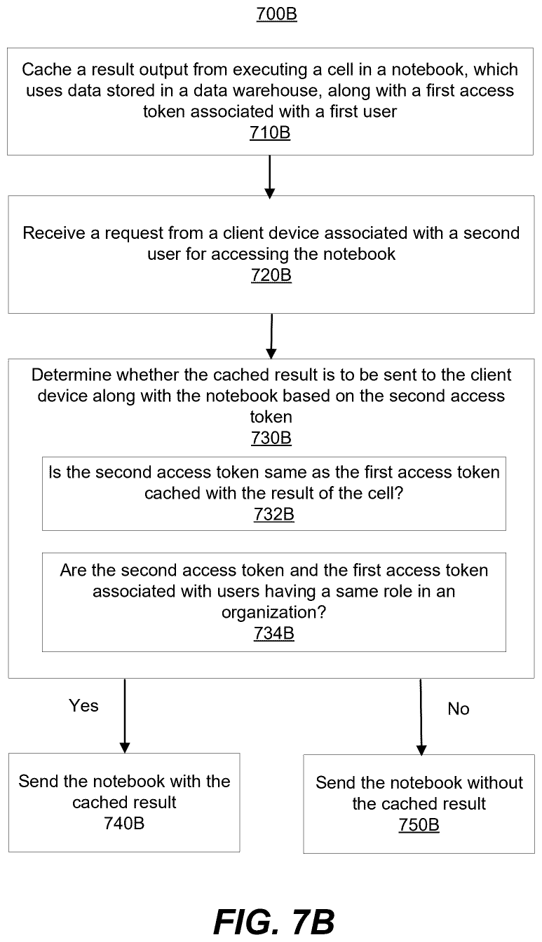

FIG. 7A is a flowchart of a method 700A for secure data access and execution in a notebook environment in accordance with one or more embodiments. The method may include more or fewer steps as depicted in FIG. 7A. In some embodiments, the method 700A may be implemented at a computing system, such as a notebook tool service provider (e.g., notebook tool 130).

The notebook tool 130 grants 710A a user permission to access a notebook. The notebook includes a plurality of cells. At least one cell from the plurality of cells includes code that requires access to data stored in a data warehouse (e.g., data warehouse 140). The notebook tool 130 receives 720A a request from a client device associated with the user for executing the cell. The notebook tool 130 obtains 730A an access token from an authentication service, and transmits 740A a request along with the access token to the data warehouse, causing the data warehouse to authenticate the access token with the authentication service (authentication service 150).

Responsive to successful authentication, the notebook tool 130 receives 750A the requested data from the data warehouse, executes 752A the code in the cell using the received data to output a result, and transmits 754A the result to the client device associated with the user. On the other hand, responsive to failed authentication, the notebook tool 130 receives 760A a rejection of the request from the data warehouse, generates 762A an error result based on the rejection of the request, and transmits 764A the error result to the client device associated with the user.

In some embodiments, the result of executing the code in the cell is cached as a part of the notebook, such that subsequent access to the notebook by the same user or a different user may be able to access the cached result without having to execute the cell again.

FIG. 7B illustrates a flowchart of a method 700B for sharing results from executing cells of a notebook using data stored at a data warehouse, in accordance with one or more embodiments. The method 700B may include more or fewer steps as depicted in FIG. 7B. In some embodiments, the method 700B may be implemented at a computing system, such as a notebook tool service provider (e.g., notebook tool 130).

The notebook tool 130 caches 710B a result that is output from executing a cell in a notebook, which uses data stored in a data warehouse, along with a first access token. The first access token is associated with a first user that was authenticated by the data warehouse, such that the first user is authorized to access the data stored in the data warehouse used to execute the cell.

The notebook tool 130 receives 720B a request from a client device associated with a second user for accessing the notebook. The second user is associated with a second access token. In some embodiments, the second access token may be obtained from the authentication service 150 after the request is received. Alternatively, the second access token may be previously obtained and securely stored in a data store accessible by the notebook tool 130. The notebook tool 130 determines 730B whether the cached result is to be sent to the client device along with the notebook based on the second access token. In some embodiments, the notebook tool 130 determines 732B whether the second access token is same as the first access token cached with the result of the cell. Responsive to determining that the second access token is same as the first access token, the notebook tool 130 determines that the cached result is to be sent to the client device. Alternatively, or in addition, the notebook tool 130 determines whether the second access token and the first access token are associated with users having a same role in an organization. Responsive to determining that the first access token and the second access token are associated with users having a same role in an organization, the notebook tool 130 determines that the cached result is to be sent to the client device.

In some embodiments, the first user may share the notebook with the second user. For example, the first user may specify that a particular second user is allowed to access the notebook and its cached results on behalf of the first user. Responsive to sharing the notebook from the first user to the second user, a first client device associated with the first user may send the second client device the first access token associated with the first user. As such, the second client device associated with the second user is able to use the first access token to gain access to the cached result.

Alternatively, the first user may specify that a group of second users that share a same role in an organization are allowed to access the notebook and its cached results. Alternatively, the first user may specify that a second user or a group of second users can only access the notebook but not the cached results. The notebook tool 130 determines whether the cached result is to be sent to the client device along with the notebook based on the specification set by the first user and the received second access token.

Responsive to determining that the cached result is to be sent to the client device along with the notebook, the notebook tool sends 740B the notebook with the cached result to the client device. Otherwise, the notebook tool 130 sends 750B the notebook without the cached result to the client device. Once the second user receives the notebook without the cached result, they can attempt to execute the cell again, which may then follow the method 700A described with respect to FIG. 7A.

The sharing of a notebook with or without cached results among different users may be in real-time. For example, a first user may share a notebook with a second user by generating and sending a link, linking to the notebook. The link may be sent to the second user via a messenger, an email, or an interface provided by the notebook tool 130. In response to receiving the link, the second user is able to access the shared notebook in real-time or near real-time. In some embodiments, when one of the users edits the notebook, the changes may be presented to other users in real-time or near real-time. “Near real-time” refers to a slight delay that is typically imperceptible to users or does not affect users' experience.

In some embodiments, after a collaboration session among multiple users is established, one of the users (also referred to as a “first user”) may take control of a notebook. Any changes made to the notebook by this user via a first client device, such as editing and execution of cells, are presented to the remaining users via their corresponding client devices in near real-time. Later, should another user (also referred to as a “second user”) wish to take control of the notebook, they may submit a request via a second client device. Responsive to receiving this request, the notebook tool 130 revokes control from the first user and enables control by the second user via the second client device. Similarly, the changes made to the notebook by the second user are also presented to all other users in near real-time.

In some embodiments, the system enforces additional governance by applying policy logic to control handoffs in collaborative sessions. Before permitting a second user to take over control of a notebook session, the system evaluates whether the incoming user has sufficient permissions to execute or even view the content of active cells. This includes checking whether the user's roles authorize access to the datasets queried in each cell. In response to determining that the user's role lacks access to any of the data referenced by the cells under execution or with visible outputs, the system may deny the takeover request or restrict edit access to only those portions of the notebook that fall within the user's permissions.

In some embodiments, when control of a notebook is transferred from a first user to a second user, the notebook tool 130 resets the execution kernel to prevent leakage or reuse of prior authentication tokens or in-memory state. This ensures that subsequent cell executions are associated only with the credentials and access rights of the current controlling user. This dynamic credential binding supports secure and auditable session handoffs during live collaboration. In some embodiments, collaboration is asynchronous rather than simultaneous. The notebook tool 130 supports secure handoffs between collaborators, where each user's credentials are independently authenticated at time of interaction. Cached results, access permissions, and schema views are all enforced per user session, ensuring that collaborators working across different geographical areas or workflows operate within their authorized scope.

### Computing Machine Architecture

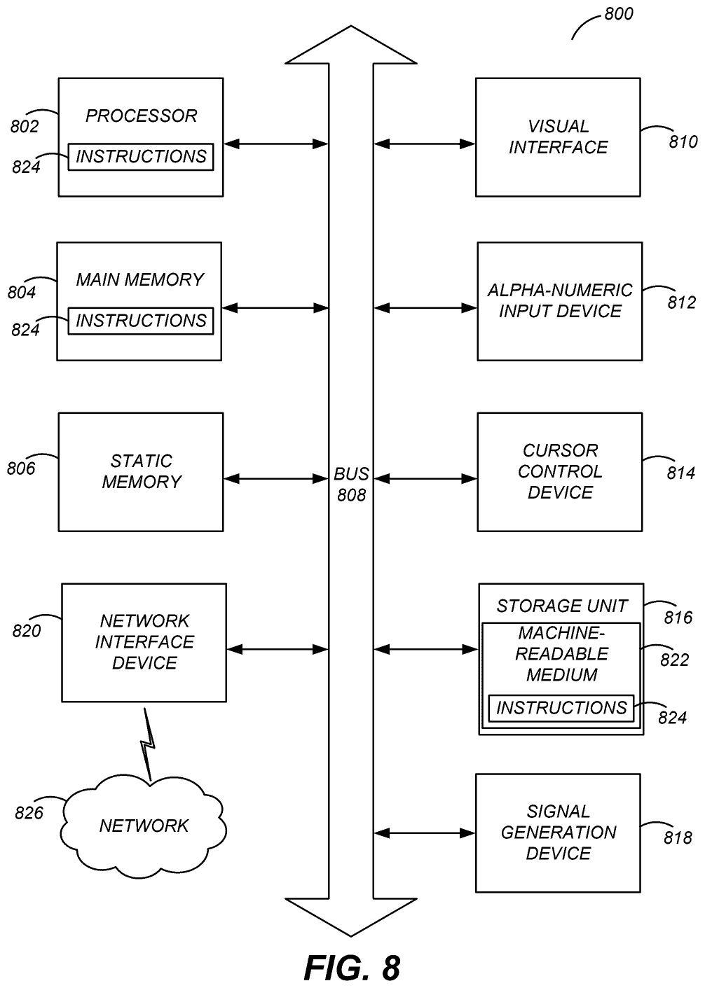

FIG. (FIG. 8 is a block diagram illustrating components of an example machine able to read instructions from a machine-readable medium and execute them in a processor (or controller). Specifically, FIG. 8 shows a diagrammatic representation of a machine in the example form of a computer system 800 within which program code (e.g., software) for causing the machine to perform any one or more of the methodologies discussed herein may be executed. The program code may be comprised of instructions 824 executable by one or more processors 802. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 824 (sequential or otherwise) that specify actions to be taken by that machine. Further, while only a single machine is illustrated, the term “machine” shall also be taken to include any collection of machines that individually or jointly execute instructions 824 to perform any one or more of the methodologies discussed herein.

The example computer system 800 includes a processor 802 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 804, and a static memory 806, which are configured to communicate with each other via a bus 808. The computer system 800 may further include visual display interface 810. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 810 may include or may interface with a touch enabled screen. The computer system 800 may also include alphanumeric input device 812 (e.g., a keyboard or touch screen keyboard), a cursor control device 814 (e.g., a mouse, a trackball, a joystick, a motion sensor, or other pointing instrument), a storage unit 816, a signal generation device 818 (e.g., a speaker), and a network interface device 820, which also are configured to communicate via the bus 808.

The storage unit 816 includes a machine-readable medium 822 on which is stored instructions 824 (e.g., software) embodying any one or more of the methodologies or functions described herein. The instructions 824 (e.g., software) may also reside, completely or at least partially, within the main memory 804 or within the processor 802 (e.g., within a processor's cache memory) during execution thereof by the computer system 800, the main memory 804 and the processor 802 also constituting machine-readable media. The instructions 824 (e.g., software) may be transmitted or received over a network 826 via the network interface device 820.

While machine-readable medium 822 is shown in an example embodiment to be a single medium, the term “machine-readable medium” should be taken to include a single medium or multiple media (e.g., a centralized or distributed database, or associated caches and servers) able to store instructions (e.g., instructions 824). The term “machine-readable medium” shall also be taken to include any medium that is capable of storing instructions (e.g., instructions 824) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for generating code for cells having dependencies shown in a DAG using generative AI through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method comprising:
receiving, from a first client device operated by a first user, a request for accessing a notebook including a plurality of cells, wherein a cell from the plurality of cells instructs retrieval of data stored in a data warehouse;
responsive to determining that the first user has permission to access the notebook, presenting a first view of the notebook in a notebook environment at the first client device;
receiving a request, from the first client device, to initialize a collaboration session to share the notebook in the notebook environment with a second user;
sending an invitation to a second client device operated by the second user, inviting the second user to join the collaboration session;
receiving a request, from the second client device, for joining the collaboration session;
responsive to determining that the second user has permission to access the notebook, establishing the collaboration session; and
presenting a second view of the notebook in the notebook environment at the second client device.

2. The method of claim 1, wherein the first view of the notebook in the notebook environment is generated based on a first role associated with the first user, and the second view of the notebook in the notebook environment is generated based on a second role associated with the second user.

3. The method of claim 1, the method further comprising receiving a request from the first client device operated by the first user to execute the cell;
transmitting a request for data along with a first access token associated with the first user to the data warehouse, causing the data warehouse to authenticate the first user based on the first access token;
responsive to successful authentication of the first access token by the data warehouse, receiving the requested data from the data warehouse;
executing the cell using the received data to output a result;
caching the result with the cell of the notebook; and
presenting an updated notebook with the cached result in the second view at the second client device in near real time.

4. The method of claim 3, the method further comprising:
determining whether the second user has permission to access the result based on a second access token associated with the second user; and
responsive to determining that the second user has permission to access the result, presenting the updated notebook with the cached result in the second view at the second client device in near real time.

5. The method of claim 4, the method determining that the second user is allowed to access the cached result comprises:
determining whether the second access token is same as the first access token;
responsive to determining that the second access token is same as the first access token, determining that the second user has permission to access the cached result.

6. The method of claim 4, wherein determining that the second user is allowed to access the cached result comprises:
authenticating whether the second user is assigned a particular role based on the second access token; and
responsive to authenticating that the second user is assigned the particular role, determining that the second user has permission to access the cached result.

7. The method of claim 4, wherein determining that the second user is allowed to access the cached result comprises:
authenticating whether the second user is assigned a same role as the first user based on the first access token and the second access token; and
responsive to authenticating that the second user is assigned the same role, determining that the second user has permission to access the cached result.

8. The method of claim 4, wherein determining that the second user is allowed to access the cached result comprises:
transmitting a data request to the data warehouse along with the second access token, causing the data warehouse to authenticate the second user with an authentication service based on the second access token;
responsive to successful authentication of the second user, determining that the second user is allowed to access the cached result.

9. The method of claim 3, the method further comprising
receiving a request from the second client device operated by the second user to take control over the notebook;
revoking control from the first client device and enabling control by the second client device over the notebook;
receiving a request from the second client device to execute the cell within the notebook;
transmitting a request for data along with a second access token associated with the second user to the data warehouse, causing the data warehouse to authenticate the second user based on the second access token;
responsive to successful authentication of the second access token by the data warehouse, receiving the requested data from the data warehouse;
executing the cell using the received data to output a result;
caching the result with the cell of the notebook; and
presenting the updated notebook with the cached result in the first view at the first client device in near real time.

10. The method of claim 4, further comprising:
associating the cached result with a role identifier; and
in response to determining that the second user is associated with a role corresponding to the role identifier, determining that the second user has permission to access the result.

11. A non-transitory computer readable storage medium for storing instructions that when executed by a client computing device cause the client computing device to perform steps comprising:
receiving, from a first client device operated by a first user, a request for accessing a notebook including a plurality of cells, wherein a cell from the plurality of cells instructs retrieval of data stored in a data warehouse;
responsive to determining that the first user has permission to access the notebook, presenting a first view of the notebook in a notebook environment at the first client device;
receiving a request, from the first client device, to initialize a collaboration session to share the notebook in the notebook environment with a second user;
sending an invitation to a second client device operated by the second user, inviting the second user to join the collaboration session;
receiving a request, from the second client device, for joining the collaboration session;
responsive to determining that the second user has permission to access the notebook, establishing the collaboration session; and
presenting a second view of the notebook in the notebook environment at the second client device.

12. The non-transitory computer readable storage medium of claim 11, wherein the first view of the notebook in the notebook environment is generated based on a first role associated with the first user, and the second view of the notebook in the notebook environment is generated based on a second role associated with the second user.

13. The non-transitory computer readable storage medium of claim 11, the steps further comprising
receiving a request from the first client device operated by the first user to execute the cell;
transmitting a request for data along with a first access token associated with the first user to the data warehouse, causing the data warehouse to authenticate the first user based on the first access token;
responsive to successful authentication of the first access token by the data warehouse, receiving the requested data from the data warehouse;
executing the cell using the received data to output a result;
caching the result with the cell of the notebook; and
presenting an updated notebook with the cached result in the second view at the second client device in near real time.

14. The non-transitory computer readable storage medium of claim 13, the steps further comprising:
determining whether the second user has permission to access the result based on a second access token associated with the second user; and
responsive to determining that the second user has permission to access the result, presenting the updated notebook with the cached result in the second view at the second client device in near real time.

15. The non-transitory computer readable storage medium of claim 14, the steps determining that the second user is allowed to access the cached result comprises:
determining whether the second access token is same as the first access token;
responsive to determining that the second access token is same as the first access token, determining that the second user has permission to access the cached result.

16. The non-transitory computer readable storage medium of claim 14, wherein determining that the second user is allowed to access the cached result comprises:
authenticating whether the second user is assigned a particular role based on the second access token; and
responsive to authenticating that the second user is assigned the particular role, determining that the second user has permission to access the cached result.

17. The non-transitory computer readable storage medium of claim 14, wherein determining that the second user is allowed to access the cached result comprises:
authenticating whether the second user is assigned a same role as the first user based on the first access token and the second access token; and
responsive to authenticating that the second user is assigned the same role, determining that the second user has permission to access the cached result.

18. The non-transitory computer readable storage medium of claim 14, wherein determining that the second user is allowed to access the cached result comprises:
transmitting a data request to the data warehouse along with the second access token, causing the data warehouse to authenticate the second user with an authentication service based on the second access token;
responsive to successful authentication of the second user, determining that the second user is allowed to access the cached result.

19. The non-transitory computer readable storage medium of claim 13, the step further comprising
receiving a request from the second client device operated by the second user to take control over the notebook;
revoking control from the first client device and enabling control by the second client device over the notebook;
receiving a request from the second client device to execute the cell within the notebook;
transmitting a request for data along with a second access token associated with the second user to the data warehouse, causing the data warehouse to authenticate the second user based on the second access token;
responsive to successful authentication of the second access token by the data warehouse, receiving the requested data from the data warehouse;
executing the cell using the received data to output a result;
caching the result with the cell of the notebook; and
presenting the updated notebook with the cached result in the first view at the first client device in near real time.

20. A computer system, comprising:
one or more processors; and
a non-transitory computer readable storage medium for storing instructions that when executed by a client computing device cause one or more processors to perform steps comprising:
receiving, from a first client device operated by a first user, a request for accessing a notebook including a plurality of cells, wherein a cell from the plurality of cells instructs retrieval of data stored in a data warehouse;
responsive to determining that the first user has permission to access the notebook, presenting a first view of the notebook in a notebook environment at the first client device;
receiving a request, from the first client device, to initialize a collaboration session to share the notebook in the notebook environment with a second user;
sending an invitation to a second client device operated by the second user, inviting the second user to join the collaboration session;
receiving a request, from the second client device, for joining the collaboration session;
responsive to determining that the second user has permission to access the notebook, establishing the collaboration session; and
presenting a second view of the notebook in the notebook environment at the second client device.
